(19) United States
(12) Patent Application Publication
(10) Pub. No.: US 2009/0098348 A1
(43) Pub. Date: Apr. 16, 2009

(54) Disease prevention workout towel with user instructions

(76) Inventor: Matthew Barker, Newbury Park, CA (US)

Correspondence Address: Lauson & Tarver LLP, 880 Apollo Street, SUITE 301, El Segundo, CA, 90245, US

(21) Appl. No.: 11/974,397

(22) Filed: Oct. 11, 2007

(51) Int. Cl. B41M 5/00

(52) U.S. Cl. 428/195.1

(57) ABSTRACT

An improved workout towel comprising user instructions in the form of indicia on each side of the towel; a first side bearing indicia that instructs a user to employ the first side of the towel on the person of the user, and a second side bearing indicia that instructs a user to employ the second side of the towel on surfaces other than the person of the user. The workout towel further comprising antimicrobial properties either applied to the towel, or incorporated into the textile comprising it, including bamboo as a textile material component comprising the towel.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Public equipment, including gym equipment, is a known carrier of microbial agents, including bacteria, fungi and viruses that cause disease. Users of gym equipment frequently use the same towel to remove perspiration and wipe off equipment, causing the towel to become a disease carrying agent. Therefore, there is a need for a device that can be used on both the person of a user, and public equipment, without transmitting disease agents from the equipment to the user.

It is therefore an object of the present invention to provide a workout towel which can be used on the person of a user and on gym equipment without transmitting disease agents to the user. A further object of the invention is to provide a workout towel with separate indicia on each side of the towel to instruct a user which side is for personal use and which side is for cleaning foreign surfaces. Still another object of the invention is to provide an indicia bearing workout towel with antimicrobial properties that neutralizes disease causing agents, and instructs users to use one side of the towel for personal use and another side for foreign surfaces.

### SUMMARY

The present invention comprises a workout towel consisting of a planar member with two sides. The first side is intended for use on the person of a user, while the second side is intended for use on surfaces excluding a user's face and body. In this manner, fluids wiped from foreign surfaces are prevented from contacting the face and body of a user.

The towel further comprises a first indicia on the first surface of the towel indicating the “FACE” of a user, and a second indicia on the second surface of the towel indicating “GYM” or an equivalent word to indicate non-personal use. Additionally, any word or logotype indicating that the first surface is for the person of a user and the second surface is not to be applied to the body of a user may be employed. The indicia on the surface of the towel may be incorporated into the fabric of the towel, or applied to the towel material.

The material comprising the towel can be any absorbent synthetic or organic material. In one preferred embodiment of the invention, the material comprising the towel has antimicrobial properties, including antibacterial and antifungal properties. The antimicrobial properties may be imparted to the material through components that are administered to the material during manufacture, or the towel may be comprised of a material with natural antimicrobial agents, such as bamboo, including bamboo in a fifty percent or greater concentration.

The size of the towel may vary, but standard dimensions, including 12 by 29 inches, 16 by 28 inches, and 12 by 24 inches are contemplated. The towel may have additional words, phrases and logotypes imprinted on it. These additional messages can be motivational in nature, or contain branding indicia.

In further preferred embodiments, a means is disposed along the edge of the towel to prevent fraying of the material, including a hem, additional fabric or other means. The towel may also be constructed with a membrane between the first and second surfaces to prevent moisture and microbial agents from migrating between the surfaces.

### FIGURES

FIG. 1 is a perspective view of the first surface of the work-out towel of the present invention.

FIG. 2 is a perspective view of the second surface of the work-out towel of the present invention.

### DESCRIPTION

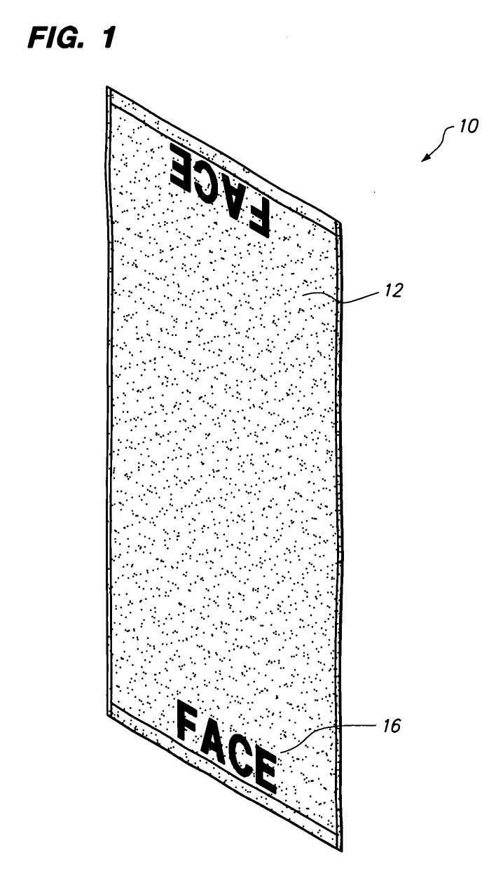

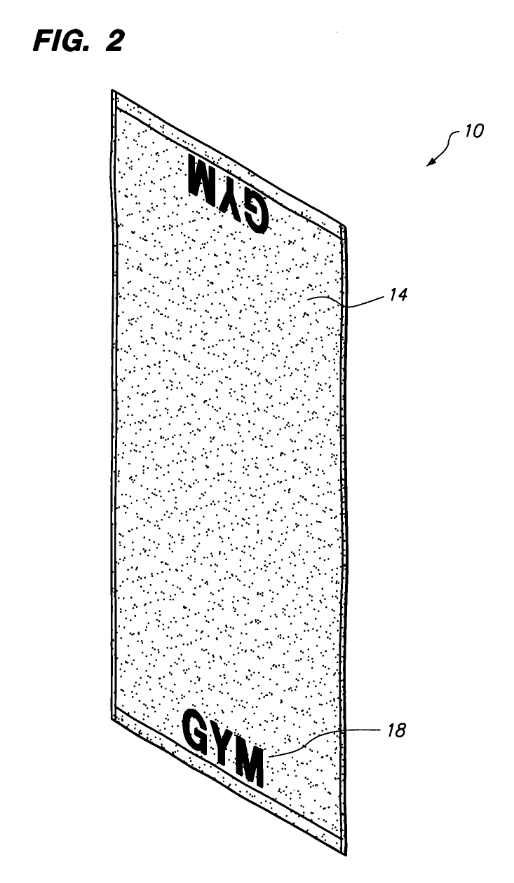

Referring to FIGS. 1 and 2, a work-out towel is shown and described wherein the towel comprises a planar member 10 with two sides. The first side 12 is intended for use on the person of a user, i.e. for removing fluids including perspiration from the user's face and body. The second side 14 is intended for use on any surface excluding the user's face and body. In this manner, fluids wiped from foreign surfaces are prevented from contacting the face and body of a user.

The first indicia 16 on the first surface of the towel may specifically indicate the “FACE” of a user, however, any word or logotype indicating any part, including the whole physical body of a user may be employed. By contrast, the second indicia 18 on the second surface of the towel may specifically indicate surfaces of the “GYM,” however any word or logotype indicating that the second surface is not to be applied to the body of a user may be employed. The indicia on the surface of the towel may be incorporated into the fabric of the towel, or applied over the material comprising the towel.

Although the material comprising the towel can be synthetic or organic in nature, the absorbent properties of the material extend to both hydrophilic (water based) and hydrophobic (oil based) fluids. In one preferred embodiment of the invention, the material comprising the towel has antimicrobial properties, including antibacterial and antifungal properties.

The antimicrobial properties may be imparted to the material through agents that are administered to the material during manufacture. However, to avoid the gradual weakening and eventual loss of the antimicrobial agents, in one preferred embodiment, the towel material comprises a material with natural antimicrobial properties. In a further preferred embodiment, a quantity of bamboo is incorporated into the material. In some instances a textile with a bamboo concentration of fifty percent or higher may be used.

Although the size of the towel may vary; from the size of a wash cloth or hand towel to a bath towel, it is contemplated that standard towel sizes will be used. Three specific embodiments of the towel have dimensions of 12 by 29 inches, 16 by 28 inches, or 12 by 24 inches, respectively.

In addition to the words, phrases or logotypes that are disposed on the towel for purposes of indicating the use of a particular side of the towel, the towel may also comprise additional words, phrases and logotypes. In various preferred embodiments, it is contemplated that these additional messages will be motivational in nature or will contain marketing messages or brand identifications.

Along the edges of the towel a means is disposed to prevent fraying of the material, including a hem, additional and alternate fabrics or other anti-fraying means. In one embodiment the towel is constructed with a membrane between the first and second surfaces to prevent microbial agents or moisture from migrating between the surfaces.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved workout towel comprising a planar member of absorbent material with two opposing surfaces, wherein a first indicia indicating a first use are disposed on a first surface of the member and a second indicia indicating a second use are disposed on a second surface of the member.

2. The towel of claim 1, wherein the member comprises a synthetic or organic material with absorbent properties.

3. The towel of claim 2, wherein the material comprises anti-microbial properties, including anti-bacterial and anti-fungal properties.

4. The towel of claim 3, wherein the anti-microbial properties are imparted to the material due to the components that comprise the material, including bamboo, or through the application of an agent to the material.

5. The towel of claim 4, wherein the bamboo comprising the towel comprises fifty percent or higher of the total composition of the towel.

6. The towel of claim 5, wherein the size of the towel comprises any size chosen from the list of 12 by 29 inches, 16 by 28 inches, or 12 by 24 inches.

7. The towel of claim 1, wherein the first indicia on the first surface of the towel indicates that the surface is for use on the person of the user, and the second indicia on the second surface of the towel indicates that the second surface is not for use on the person of a user.

8. The towel of claim 7, wherein the first indicia indicates that the first surface is for a user's face and body only, and the second indicia indicates that the second surface is for the equipment and floor of a gym.

9. The towel of claim 8, wherein the first indicia comprises a phrase including the words “FACE” or “BODY” and the second surface indicia comprises a phrase including the word “GYM”.

10. The towel of claim 8, wherein the first indicia comprises the phrase “FACE AND BODY” and the second indicia comprises the phrase “EQUIPMENT AND FLOOR.”

11. The towel of claim 8, wherein the first and second surface indicia comprise logotype images to convey that the first surface is for use on the person of a user, and the second surface is not for use on the person of a user.

12. The towel of claim 1, wherein additional indicia, including words, phrases or logotypes are disposed on either side, including both sides of the towel.

13. The towel of claim 12, wherein the additional indicia comprises motivational messages.

14. The towel of claim 12, wherein the additional indicia comprises marketing or brand identifying trademarks.

15. The towel of claim 1, wherein a means to prevent fraying of the material is disposed along the edges of the towel.

16. The towel of claim 1, wherein a barrier is disposed between the first surface and the second surface to prevent microbial agents from migrating between the surfaces.

17. The towel of claim 1, wherein the indicia are incorporated into the material that comprises the towel.

18. The towel of claim 1, wherein the indicia are applied to the surface of the material that comprises the towel.
